(19) United States
(12) Patent Application Publication
(10) Pub. No.: US 2017/0334164 A1
(43) Pub. Date: Nov. 23, 2017

(54) FOUR-LAYER FABRIC

(71) Applicant: Jen-Huan LU, New Taipei City (TW)

(72) Inventor: Jen-Huan LU, New Taipei City (TW)

(21) Appl. No.: 15/157,316

(22) Filed: May 17, 2016

(51) Int. Cl. B32B 5/18; B32B 5/02; B32B 7/12

(52) U.S. Cl. CPC B32B 5/18; B32B 7/12; B32B 5/02; B32B 2307/724; B32B 2307/73; B32B 2250/04

(57) ABSTRACT

A four-layer fabric includes a first fiber layer; a waterproof, breathable layer secured to a bottom of the first fiber layer; a foam layer having a top secured to a bottom of the waterproof, breathable layer by melting, and a bottom; and a second fiber layer secured to the bottom of the foam layer by melting. In addition to insulation against cold condition, the four-layer fabric is waterproof, breathable, and capable of absorbing shock due to padding nature.

### BACKGROUND OF THE INVENTION

### 1. Field of the Invention

The invention relates to fabric and more particularly to a four-layer fabric including a waterproof, breathable layer secured to a bottom of a first fiber layer, a foam layer secured to a bottom of the waterproof, breathable layer, and a second fiber layer secured to a bottom of the foam layer, in addition to insulation against cold condition, the four-layer fabric being waterproof, breathable, and capable of absorbing shock due to padding nature.

### 2. Description of Related Art

Textiles have an assortment of uses, the most common of which are for clothing. Clothes can insulate against cold or hot conditions. Moreover, additional functions such as being waterproof and breathable are desired as technologies advance.

A conventional waterproof three-layer fabric is shown in FIG. 8 and comprises a first fiber layer 90, a waterproof layer 91 secured to a bottom of the first fiber layer 90, and a second fiber layer 92 secured to a bottom of the waterproof layer 91. While the waterproof three-layer fabric is capable of being impervious to water due to the provision of the waterproof layer 91, it is not capable of allowing moisture vapor to be transmitted through it. Further, its insulation against cold condition is poor. Furthermore, its elasticity and shock absorbing capability are poor.

Another conventional fabric is manufactured by coating a non-porous, hydrophilic membrane on a fiber layer or forming a non-porous, hydrophilic membrane and securing the non-porous, hydrophilic membrane to a fiber layer. However, the non-porous, hydrophilic membrane is subject to disengagement from the fiber layer after expanding by contacting water. Further, its insulation against cold condition, elasticity, and shock absorbing capability are poor.

Thus, the need for improvement still exists.

### SUMMARY OF THE INVENTION

It is therefore one object of the invention to provide a four-layer fabric comprising a first fiber layer; a waterproof, breathable layer secured to a bottom of the first fiber layer; a foam layer having a top secured to a bottom of the waterproof, breathable layer by melting, and a bottom; and a second fiber layer secured to the bottom of the foam layer by melting.

Preferably, the first fiber layer is secured to the waterproof, breathable layer either (i) by applying adhesive on a plurality of spaced positions on the bottom of the first fiber layer or the top of the waterproof, breathable layer prior to joining them or (ii) by applying adhesive on all areas of the bottom of the first fiber layer or the top of the waterproof, breathable layer prior to joining them.

Preferably, the foam layer is made of foam having a thickness of 2.5 mm.

Preferably, the top and the bottom of the foam layer are melted at a temperature of 300° C. in a manufacturing process.

Preferably, sequentially the top of the foam layer is secured to the waterproof, breathable layer by melting and pressing, the foam layer is cooled, and the bottom of the foam layer is secured to the second fiber layer by melting and pressing in a manufacturing process.

Preferably, the first fiber layer and the second fiber layer are made of the same fiber.

Preferably, the first fiber layer and the second fiber layer are made of different fiber.

The invention has the following advantages and benefits in comparison with the conventional art:

Both the top and the bottom of the foam layer are melted at a temperature of 300° C. in a first step of the manufacturing process. Sequentially the top of the foam layer is secured to the waterproof, breathable layer by melting and pressing, the foam layer is cooled, and the bottom of the foam layer is secured to the second fiber layer by melting and pressing in a final step of the manufacturing process. Specifically, the first fiber layer is secured to the waterproof, breathable layer by applying adhesive on a plurality of spaced positions on the bottom of the first fiber layer or the top of the waterproof, breathable layer prior to joining them. Alternatively, the first fiber layer is secured to the waterproof, breathable layer by applying adhesive on all areas of the bottom of the first fiber layer or the top of the waterproof, breathable layer prior to joining them. In addition to insulation against cold condition, the four-layer fabric is waterproof, breathable, and capable of absorbing shock due to padding nature.

The above and other objects, features and advantages of the invention will become apparent from the following detailed description taken with the accompanying drawings.

### BRIEF DESCRIPTION OF THE DRAWINGS

FIG. 1 is a perspective view of a four-layer fabric according to the invention;

FIG. 2 is a detailed view of the area in a circle shown in FIG. 1;

FIG. 3 is an exploded view of the four-layer fabric;

FIG. 4 is another exploded view of the four-layer fabric;

FIG. 5 is an environmental view showing a piece of clothing made of the four-layer fabric worn on the arm for illustrating shock absorbing capability of the clothing;

FIG. 5A is a detailed view of the area in a circle shown in FIG. 5;

FIG. 6 is a longitudinal sectional view of the four-layer fabric for illustrating its waterproof capability;

FIG. 7 is a view similar to FIG. 6 for illustrating its breathability; and

FIG. 8 is a longitudinal sectional view of a conventional waterproof three-layer fabric.

### DETAILED DESCRIPTION OF THE INVENTION

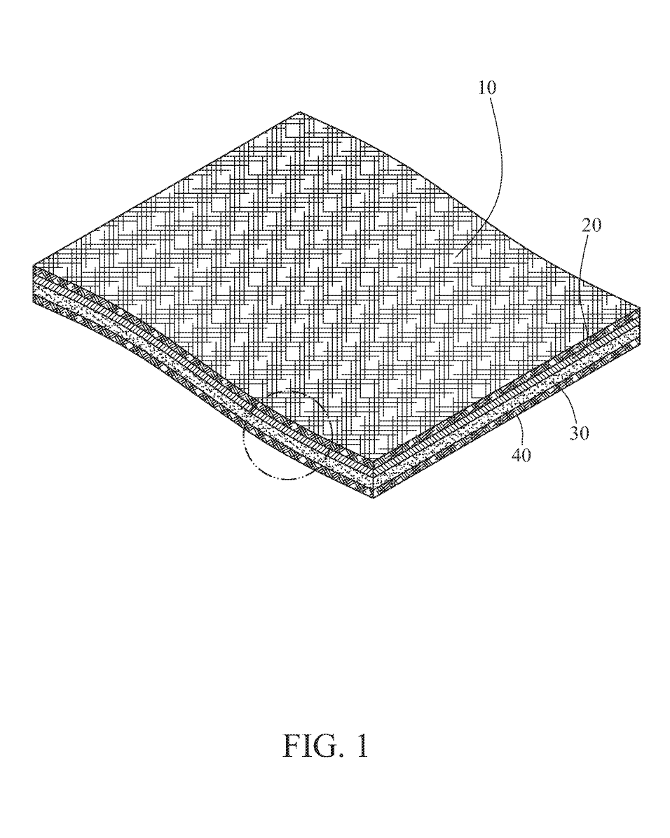

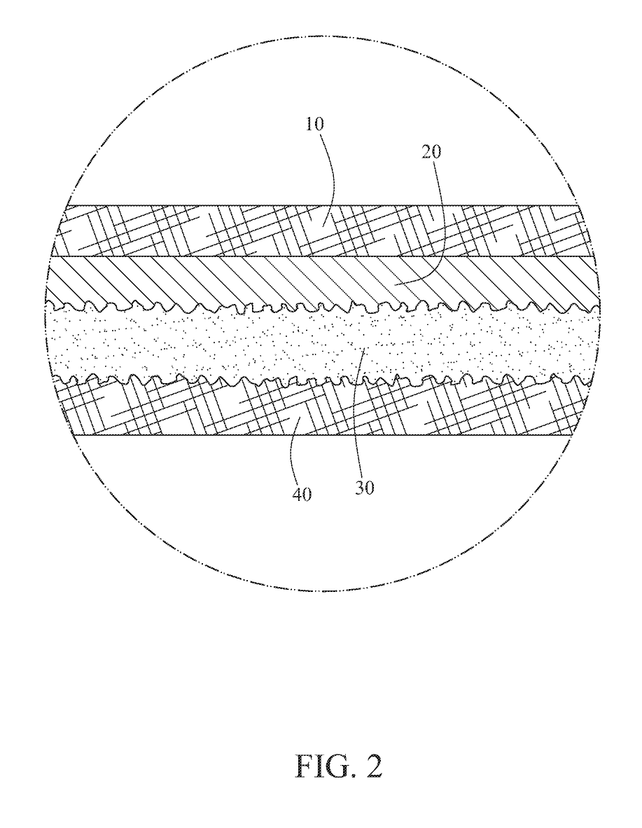

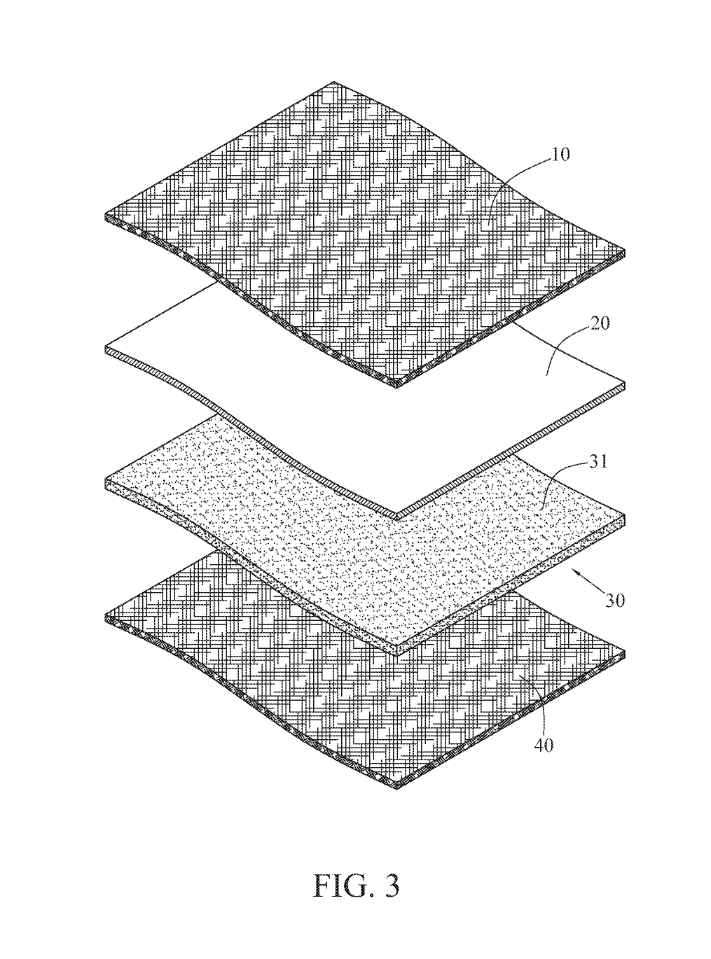

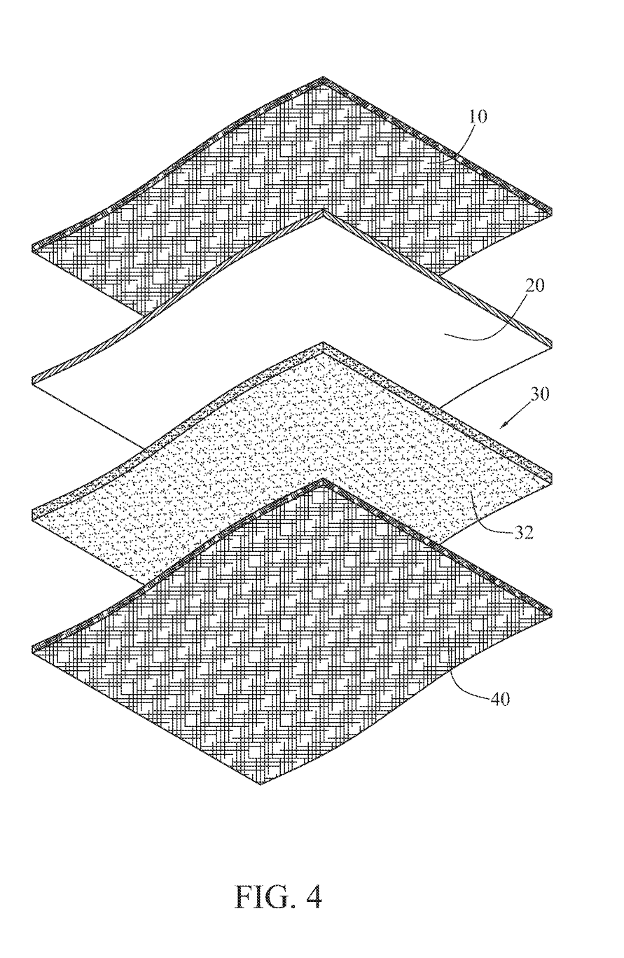

Referring to FIGS. 1 to 7, a four-layer fabric in accordance with the invention comprises the following components as discussed in detail below.

A first fiber layer 10 is provided. A waterproof, breathable layer 20 is secured to a bottom of the first fiber layer 10. A foam layer 30 has a top 31 secured to a bottom of the waterproof, breathable layer 20 by melting, and a bottom 32. A second fiber layer 40 is secured to the bottom 32 of the foam layer 30 by melting.

Preferably, the first fiber layer 10 is secured to the waterproof, breathable layer 20 by applying adhesive on a plurality of spaced positions on the bottom of the first fiber layer 10 or the top of the waterproof, breathable layer 20 prior to joining them. Alternatively, the first fiber layer 10 is secured to the waterproof, breathable layer 20 by applying adhesive on all areas of the bottom of the first fiber layer 10 or the top of the waterproof, breathable layer 20 prior to joining them.

Preferably, the foam layer 30 is made of foam having a thickness of 2.5 mm.

Preferably, the top 31 and the bottom 32 of the foam layer 30 are melted at a temperature of 300° C. in the manufacturing process.

Preferably, sequentially the top 31 of the foam layer 30 is secured to the waterproof, breathable layer 20 by melting and pressing, the foam layer 30 is cooled, and the bottom of the foam layer 30 is secured to the second fiber layer 40 by melting and pressing in the manufacturing process.

Preferably, the first fiber layer 10 and the second fiber layer 40 are made of the same fiber.

Preferably, the first fiber layer 10 and the second fiber layer 40 are made of different fiber.

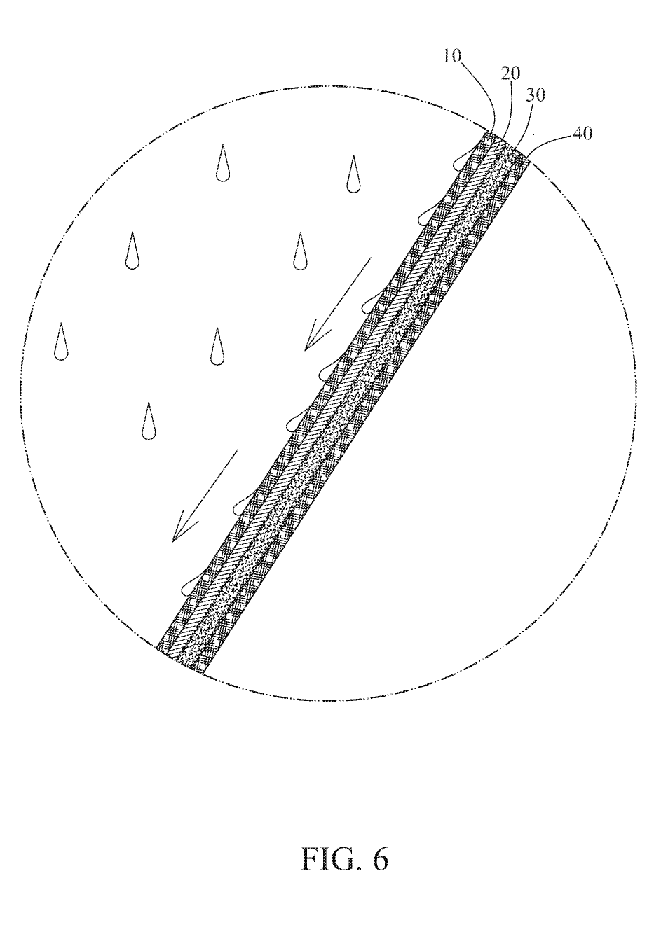

As shown in FIG. 6 specifically, it shows a piece of clothing made of the four-layer fabric of the invention being impervious to water when an individual wears the piece of clothing in a rainy day.

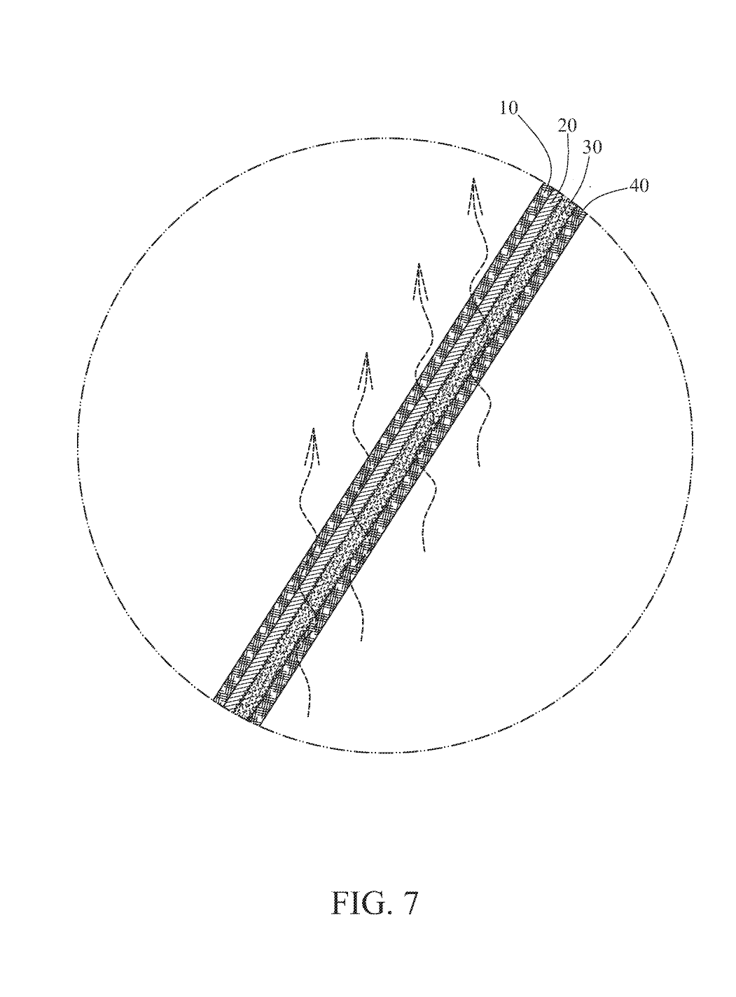

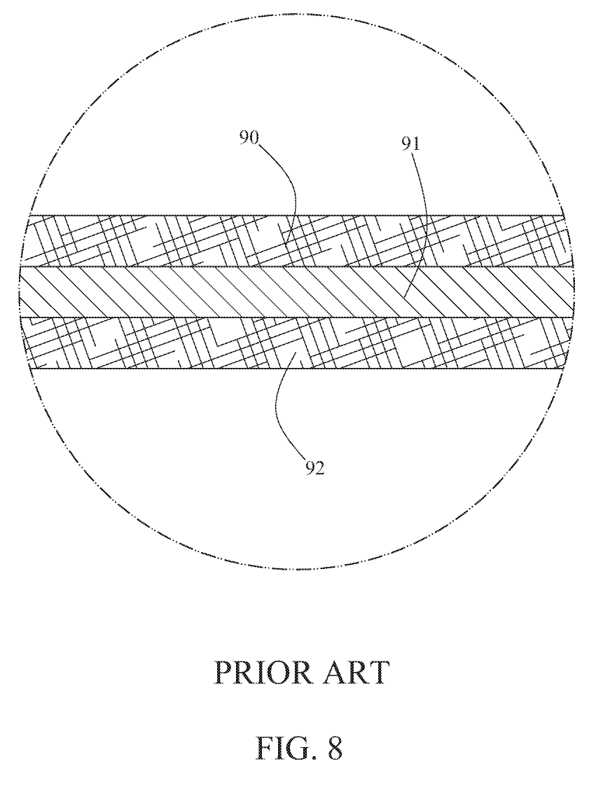

As shown in FIG. 7 specifically, it shows a piece of clothing made of the four-layer fabric of the invention being capable of allowing moisture vapor to be transmitted through it when an individual wears the piece of clothing, i.e., for removing heat generated by the body.

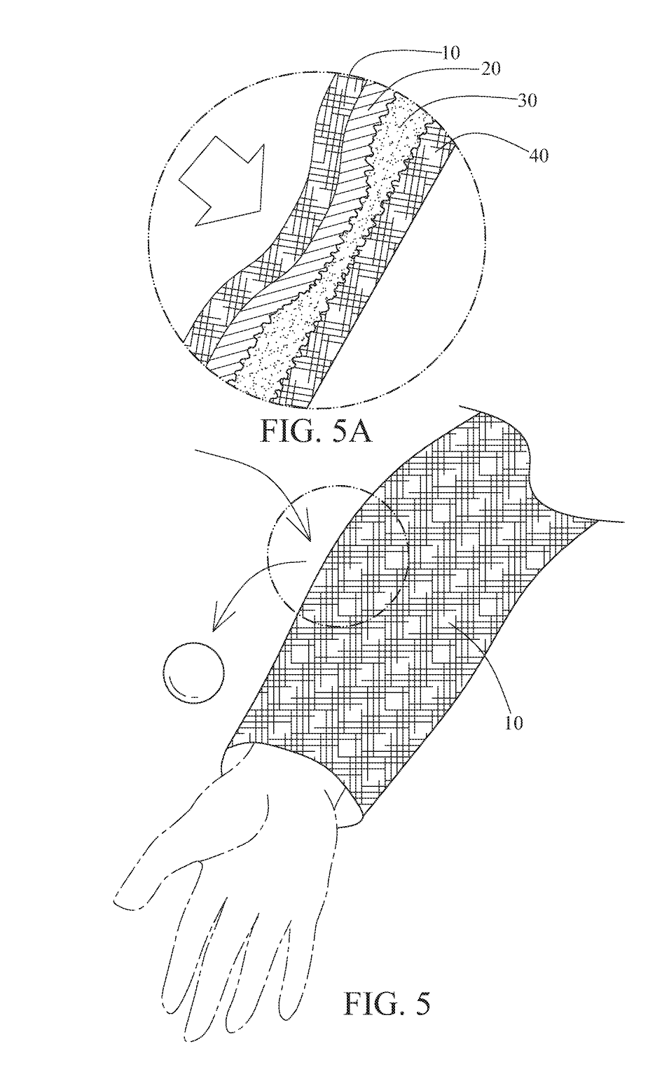

As shown in FIGS. 5 and 5A specifically, it shows a piece of clothing made of the four-layer fabric of the invention being capable of not only insulating against cold condition but also absorbing shock and jarring due to the provision of the foam layer 30 when an individual wears the piece of clothing.

It is envisaged by the invention that in addition to clothing described in above embodiments, the four-layer fabric can be made into shoes, hats, backpacks, handbags, or other personal items.

While the invention has been described in terms of preferred embodiments, those skilled in the art will recognize that the invention can be practiced with modifications within the spirit and scope of the appended claims.

What is claimed is:

1. A four-layer fabric comprising:
a first fiber layer;
a waterproof, breathable layer secured to a bottom of the first fiber layer;
a foam layer having a top secured to a bottom of the waterproof, breathable layer by melting, and a bottom; and
a second fiber layer secured to the bottom of the foam layer by melting.

2. The four-layer fabric of claim 1, wherein the first fiber layer is secured to the waterproof, breathable layer either (i) by applying adhesive on a plurality of spaced positions on the bottom of the first fiber layer or the top of the waterproof, breathable layer prior to joining them or (ii) by applying adhesive on all areas of the bottom of the first fiber layer or the top of the waterproof, breathable layer prior to joining them.

3. The four-layer fabric of claim 1, wherein the foam layer is made of foam having a thickness of 2.5 mm.

4. The four-layer fabric of claim 1, wherein the top and the bottom of the foam layer are melted at a temperature of 300° C. in a manufacturing process.

5. The four-layer fabric of claim 1, wherein sequentially the top of the foam layer is secured to the waterproof, breathable layer by melting and pressing, the foam layer is cooled, and the bottom of the foam layer is secured to the second fiber layer by melting and pressing in a manufacturing process.

6. The four-layer fabric of claim 1, wherein the first fiber layer and the second fiber layer are made of the same fiber.

7. The four-layer fabric of claim 1, wherein the first fiber layer and the second fiber layer are made of different fiber.
